(19) United States
(12) Patent Application Publication
(10) Pub. No.: US 2026/0236643 A1
(43) Pub. Date: Aug. 13, 2026

(54) ELECTRONIC DEVICE AND METHOD

(71) Applicant: SAMSUNG ELECTRONICS CO., LTD., Suwon-si (KR)

(72) Inventors: Hunsik SHIN, Suwon-si (KR); Yun Sang PARK, Suwon-si (KR); Ho-Kuen SHIN, Suwon-si (KR); Sungjoo SUH, Suwon-si (KR)

(73) Assignee: SAMSUNG ELECTRONICS CO., LTD., Suwon-si (KR)

(21) Appl. No.: 19/310,370

(22) Filed: Aug. 26, 2025

(30) Foreign Application Priority Data
Feb. 11, 2025 (KR) 10-2025-0017523

(51) Int. Cl. G06F 30/27; G06F 111/10; G06F 119/22; H01L 21/66

(52) U.S. Cl. CPC G06F 30/27; H10P 74/23; G06F 2111/10; G06F 2119/22

(57) ABSTRACT

A processor-implemented method includes acquiring a data set for a plurality of factors, which is associated with a semiconductor fabrication process, of a plurality of chips included in a wafer, generating a first sub-data set corresponding to a first area among a plurality of areas in the wafer by dividing the data set based on location data corresponding to each of the plurality of chips, the location data included in the data set, identifying, from among the plurality of factors, one or more factors satisfying a condition that is set for the first sub-data set, and learning a first estimation model corresponding the first area based on a second sub-data set for the one or more factors of a chip included in the first area.

### CROSS-REFERENCE TO RELATED APPLICATIONS

This application claims the benefit under 35 USC § 119(a) of Korean Patent Application No. 10-2025-0017523, filed on Feb. 11, 2025 in the Korean Intellectual Property Office, the entire disclosure of which is incorporated herein by reference for all purposes.

### BACKGROUND

### 1. Field

The following description relates to an electronic device and method.

### 2. Description of the Related Art

Semiconductors may be implemented in personal computers, mobile technologies, home appliances, and vehicles. Also, high-tech devices may require the high-density integration of a semiconductor device. In the process of the high-density integration of the semiconductor device, technologies using data acquired in a semiconductor fabrication process may not effectively improve a yield.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes acquiring a data set for a plurality of factors, which is associated with a semiconductor fabrication process, of a plurality of chips included in a wafer, generating a first sub-data set corresponding to a first area among a plurality of areas in the wafer by dividing the data set based on location data corresponding to each of the plurality of chips, the location data included in the data set, identifying, from among the plurality of factors, one or more factors satisfying a condition that is set for the first sub-data set, and learning a first estimation model corresponding the first area based on a second sub-data set for the one or more factors of a chip included in the first area.

The generating of the first sub-data set may include identifying chips included in each of the plurality of areas based on the location data corresponding to each of the plurality of chips, and generating a plurality of sub-data sets corresponding to the plurality of areas by dividing the data set by area in which each of the plurality of chips is included.

The plurality of areas may be determined based on a distance from a center of the wafer.

The plurality of areas may be determined based on a measurement point with respect to a distance from a center of the wafer.

The plurality of areas may be determined based on a distribution of defective chips with respect to a distance from a center of the wafer.

The one or more factors satisfying the condition that is set for the first sub-data set may include any one or any combination of any two or more of a factor of which corresponding data is included in the first sub-data set, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of the first estimation model is greater than or equal to a second threshold value, and a factor of which a value showing a contribution to an output of the first estimation model is greater than or equal to a second percentile among the plurality of factors.

The learning of the first estimation model may include preprocessing the second sub-data set, and performing an operation of imputation of missing data in the second sub-data set.

The method may include estimating a defect rate of the chip included in the first area by using a first estimation model.

The plurality of factors may include a factor for a plurality of apparatuses used in the semiconductor fabrication process, and a factor for a plurality of measurement items measured in the semiconductor fabrication process.

The method may include learning a second estimation model corresponding to a second area different from the first area among the plurality of areas, and generating an integrated model including the first estimation model and the second estimation model.

The generating of the first sub-data set may include generating the first sub-data set by dividing the data set based on a plurality of areas determined by clustering the plurality of chips, and the method may include identifying an area corresponding to location data that is a subject of defect estimation among the plurality of areas, identifying, from among a plurality of estimation models individually corresponding to the plurality of areas, the learned first estimation model as an estimation model corresponding to the area, and estimating whether a pattern corresponding to the location data that is the subject of defect estimation is a defective pattern based on the estimation model corresponding to the area.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes acquiring a data set for a plurality of factors, which is associated with a semiconductor fabrication process, of a plurality of chips included in a wafer; generating a first sub-data set corresponding to a first area among a plurality of areas in the wafer by dividing the data set based on a plurality of areas determined by clustering the plurality of chips, identifying, from among the plurality of factors, one or more factors satisfying a condition that is set for the first sub-data set, and learning a first estimation model corresponding the first area based on a second sub-data set for the one or more factors of a chip included in the first area.

The generating of the first sub-data set may include identifying, for each of the plurality of chips, a number of factors of which corresponding data is included in the data set, and determining the plurality of areas by clustering the plurality of chips based on the number of the factors which are included in the data set, which is identified for each of the plurality of chips.

The one or more factors satisfying the condition that is set for the first sub-data set may include any one or any combination of any two or more of a factor of which corresponding data is included in the first sub-data set, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of the first estimation model is greater than or equal to a second threshold value, and a factor of which a value showing a contribution to an output of the first estimation model is greater than or equal to a second percentile among the plurality of factors.

The learning of the first estimation model may include preprocessing the second sub-data set, and performing an operation of imputation of missing data in the second sub-data set.

The method may include estimating a defect rate of the chip included in the first area by using a first estimation model.

The plurality of factors may include a factor for a plurality of apparatuses used in the semiconductor fabrication process, and a factor for a plurality of measurement items measured in the semiconductor fabrication process.

In one or more general aspects, a processor-implemented method includes identifying an area corresponding to location data that is a subject of defect estimation among a plurality of areas included in a wafer, identifying an estimation model corresponding to the area among a plurality of estimation models individually corresponding to the plurality of areas, and estimating whether a pattern corresponding to the location data is a defective pattern based on the estimation model.

The plurality of estimation models individually corresponding to the plurality of areas may be models that have learned a defect pattern corresponding to each of the plurality of areas based on a sub-data set corresponding to each of the plurality of areas.

In one or more general aspects, an electronic device includes one or more processors comprising processing circuitry, and memory comprising one or more storage media storing instructions that, when executed individually or collectively by the one or more processors, cause the electronic device to generate a first sub-data set corresponding to a first area among a plurality of areas in a wafer by dividing a data set based on location data corresponding to each of a plurality of chips included in the wafer, wherein the data set is for a plurality of factors of the plurality of chips, and the plurality of factors is associated with a semiconductor fabrication process, identify, from among the plurality of factors, one or more factors satisfying a condition that is set for the first sub-data set, and learn a first estimation model corresponding the first area based on a second sub-data set for the one or more factors of a chip included in the first area.

Other features and aspects will be apparent from the following detailed description, the drawings, and the claims.

### BRIEF DESCRIPTION OF THE DRAWINGS

FIG. 1 illustrates a process of an electronic device acquiring a data set for a plurality of factors, which is associated with a semiconductor fabrication process, of a plurality of chips included in a wafer according to one or more embodiments.

FIG. 2 illustrates an example of a data set for a plurality of factors, which is associated with a semiconductor fabrication process, of a plurality of chips included in a wafer according to one or more embodiments.

FIG. 3A illustrates a process of an electronic device learning a model for estimating a defect rate of a chip according to one or more embodiments.

FIG. 3B illustrates an example of a plurality of areas in a wafer according to one or more embodiments.

FIG. 3C illustrates an example of a plurality of areas in a wafer determined based on a measurement point according to one or more embodiments.

FIG. 3D illustrates an example of a plurality of areas in a wafer determined based on a distribution of defective chips according to one or more embodiments.

FIG. 4A illustrates a process of an electronic device learning a model for estimating a defect rate of a chip according to one or more embodiments.

FIG. 4B illustrates a process of an electronic device determining a plurality of areas in a wafer based on a number of factors corresponding to chips according to one or more embodiments.

FIG. 5 illustrates a process of an electronic device generating a plurality of sub-data sets by dividing a data set according to one or more embodiments.

FIG. 6 illustrates a process of an electronic device identifying a factor satisfying a condition that is set for a sub-data set according to one or more embodiments.

FIG. 7 illustrates a process of an electronic device identifying a factor satisfying a condition that is set for a sub-data set according to one or more embodiments.

FIG. 8 is a flowchart illustrating an operation method for an electronic device according to one or more embodiments.

FIG. 9 is a flowchart illustrating an operation method for an electronic device according to one or more embodiments.

FIG. 10 is a flowchart illustrating an operation method for an electronic device according to one or more embodiments.

FIG. 11 is a block diagram illustrating an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of the relevant art and specifically in the context of the present disclosure, and are not to be construed as an ideal or excessively formal meaning unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

In the following description, one or more embodiments of the present disclosure will be described in detail with reference to the accompanying drawings so that those skilled in the art can easily carry out the present disclosure. However, the present disclosure may be embodied in many different forms and is not limited to the one or more embodiments described herein.

Hereinafter, the one or more embodiments of the present disclosure will be described with reference to the accompanying drawings.

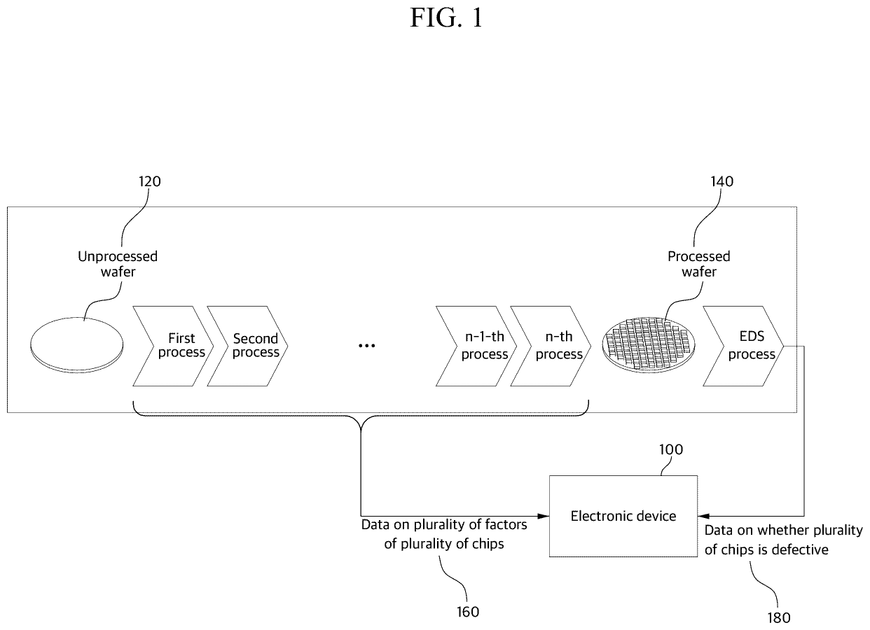

FIG. 1 illustrates a process of an electronic device 100 acquiring a data set for a plurality of factors, which is associated with a semiconductor fabrication process, of a plurality of chips included in a wafer according to one or more embodiments.

The electronic device 100 may identify the data set for the plurality of factors, which is associated with the semiconductor fabrication process, of the plurality of chips according to one or more embodiments. For example, the electronic device 100 may acquire category data on a plurality of apparatuses used in a semiconductor fabrication process of a processed wafer and measurement data on a plurality of measurement items measured in the semiconductor fabrication process of the processed wafer.

For example, referring to FIG. 1, various processes such as an oxidation process, a photolithography process, an etching process, a deposition process, an ion implantation process, a metallization process, and a measurement process may be performed n times according to a set order and combination for an unprocessed wafer 120, and as a result of the processes being performed, a processed wafer 140 may be produced. The electronic device 100 may acquire a data set 160 for a plurality of factors of the plurality of chips, which is category data on a plurality of apparatuses used in a process for a plurality of chips included in the processed wafer 140 and sequential data including measurement data measured for the plurality of chips.

The plurality of factors, which is associated with the semiconductor fabrication process, may include a factor for the plurality of apparatuses used in the semiconductor fabrication process and a factor for the plurality of measurement items measured in the semiconductor fabrication process. The factor for the plurality of apparatuses used in the semiconductor fabrication process may include identification information on an apparatus, model information on an apparatus, identification information on a chamber in the apparatus, process program identification (PPID) information, reticle information, and/or the like. However, it is merely an example. In addition, the factor for the plurality of measurement items measured in the semiconductor fabrication process may include temperature, pressure, a gas flow amount, humidity, a thickness, a flatness, a line width, a reflectance, and/or the like of a sample chip. However, it is merely an example.

According to one or more embodiments, the electronic device 100 may identify data on whether the plurality of chips is defective. For example, referring to FIG. 1, the electronic device 100 may acquire data 180 on whether the plurality of chips is defective, which shows whether each of the plurality of chips included in the processed wafer 140 is a prime good chip or a defective chip, based on a result of an electrical die sorting (EDS) process for the processed wafer 140.

According to one or more embodiments, the electronic device 100 may learn (e.g., train) a model, which is for estimating defect rates of the plurality of chips, based on the data set for the plurality of factors, which is associated with the semiconductor process of the plurality of chips, and the data on whether the plurality of chips is defective. For example, the electronic device 100 may perform supervised learning of the model for estimating the defect rates of the plurality of chips with the data set 160 for the plurality of factors of the plurality of chips and the data 180 on whether the plurality of chips is defective as input data and answer data, respectively. However, a method in which the electronic device 100 learns the model for estimating the defect rates of the plurality of chips may include unsupervised learning, semi-supervised learning, and/or reinforced learning as well as the above-mentioned supervised learning, may not be limited to such learning methods, and may include various learning methods.

Meanwhile, when the processed wafer 140 includes a greatly large number of chips, for productivity and efficiency, measurement data on some sample chips may be acquired instead of acquiring measurement data on all the chips included in the wafer 140 in the semiconductor fabrication process. As a result, the data set 160 for the plurality of factors of the plurality of chips which has tabular shapes may include a greatly large number of missing values, and a process of imputation for replacing a missing value with an average value or a value measured for another chip may be included in order to input the data set 160 to the model for the estimating. However, in a typical method, as the number of replaced values are increased, performance of the learned model for the estimating is lowered based thereon. Thus, to solve this technical problem of the typical method, a method of one or more embodiments may effectively process missing data.

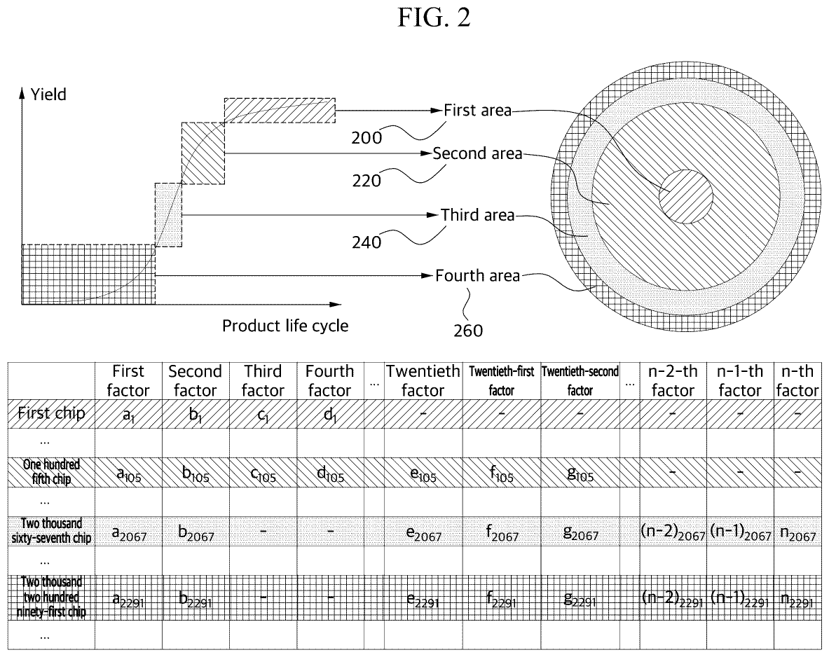

FIG. 2 illustrates an example of a data set for a plurality of factors, which is associated with a semiconductor fabrication process, of a plurality of chips included in a wafer according to one or more embodiments.

According to one or more embodiments, the plurality of chips included in the wafer may have different defect rates and defect generation factors based on respective positions thereof. For example, a defect rate may be increased as a chip is positioned farther from a center of the wafer. This may be because a crystal structure of the wafer itself is not uniform, because the semiconductor fabrication process may not be uniformly performed for the entire wafer, because a crack or a defect has a possibility of occurring as greater mechanical stress is applied to an edge portion of the wafer, because the edge portion has a high possibility of being physically and greatly affected when the wafer is gripped with a robot arm or a clamp during transfer of the wafer, because chips positioned at an edge have a high possibility of receiving a larger mechanical stress in a process of sawing a completed wafer into an individual chip, and/or the like. However, a reason why the defect rates are different based on the positions of the chips is not limited to the above description.

In addition, a time for development may vary for each of the plurality of areas in the wafer in consideration of a defect rate and a defect generation factor according to a position of a chip. For example, referring to FIG. 2, the wafer may be divided into a first area 200, a second area 220, a third area 240, and a fourth area 260 according to a distance from the center of the wafer. The defect rates of the included chips may be placed from highest to lowest in order in which the fourth area 260, the third area 240, the second area 220, and the first area 200 are far from the center of the wafer. Accordingly, in an initial stage of a product life cycle, a process of optimizing parameter values of the semiconductor fabrication process in order to decrease defect rates of chips included in the fourth area 260 may be performed. In a middle stage and a late stage, a process of optimizing the parameter values of the semiconductor fabrication process in order of the third area 240, the second area 220, and the first area 220 may be performed. As a result, a yield according to the product life cycle of the wafer may be shown as illustrated in FIG. 2.

The parameter values of the semiconductor fabrication process may include parameter values acquired in various fabrication processes. For example, strength of exposure to light (e.g., extreme ultraviolet (EUV) and/or deep ultraviolet (DUV)), a focus range, a thickness of photoresist in a photolithography process, a plasma energy source, gas composition, pressure, and wafer disposition in an etching process, deposition speed, plasma power, a gas flow amount, and temperature in a deposition process, and/or the like.

Meanwhile, the data set for the plurality of factors, which is associated with the semiconductor fabrication process, of the plurality of chips included in the wafer may include a missing value according to the product life cycle. For example, since an area of development varies depending on whether the product lift cycle of the wafer for which the semiconductor fabrication process is currently performed is at the initial stage, the middle stage, or the late stage, sample chips of which measurement data is acquired may be different. Accordingly, referring to FIG. 2, with respect to a first chip included in the first area 200, data corresponding to twentieth to twenty-second factors and n-2-th to n-th factors may not be acquired. With respect to a one hundred fifth chip included in the second area 220, data corresponding to the n-2-th to n-th factors may not be acquired. With respect to a two thousand sixty-seventh chip included in the third area 240 and a two thousand ninety-first chip included in the fourth area 260, data corresponding to a third factor and a fourth factor may not be acquired.

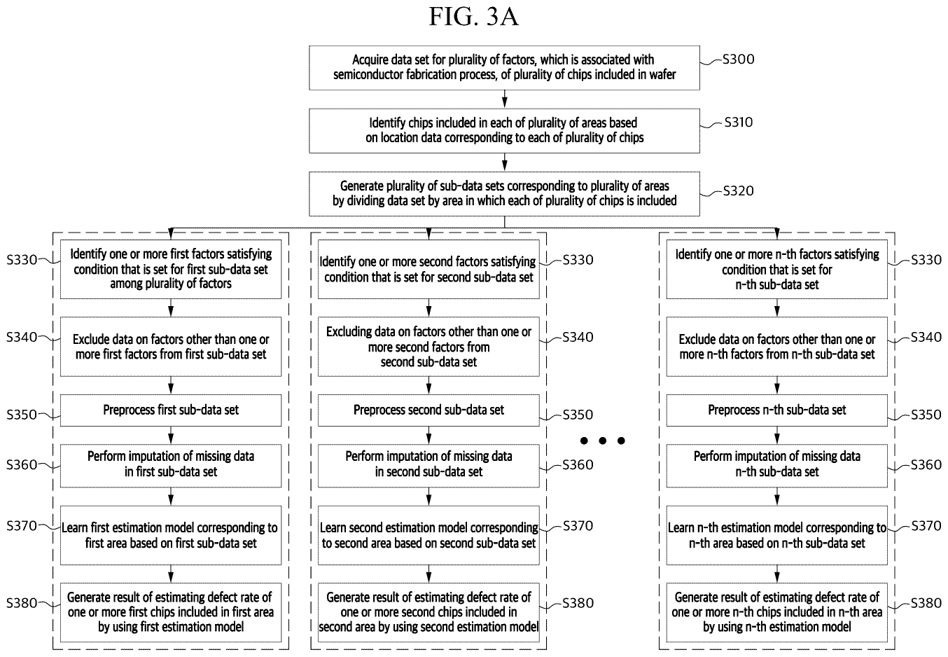

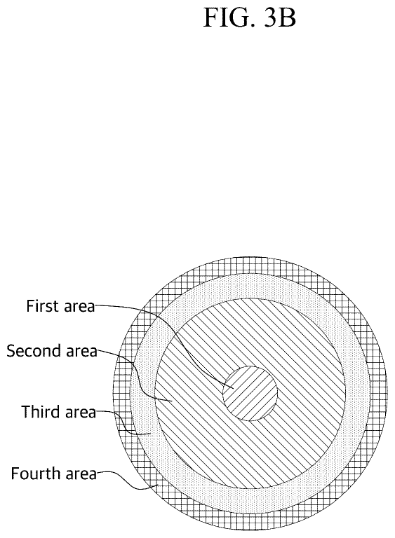

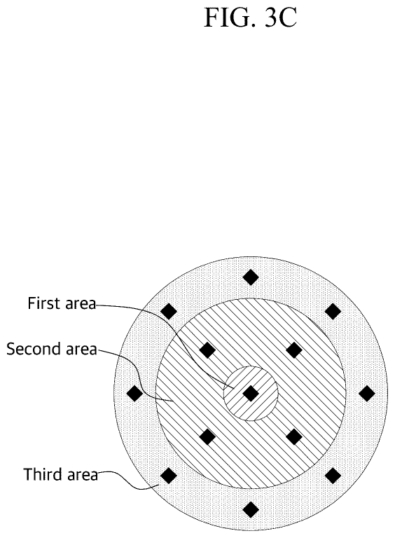

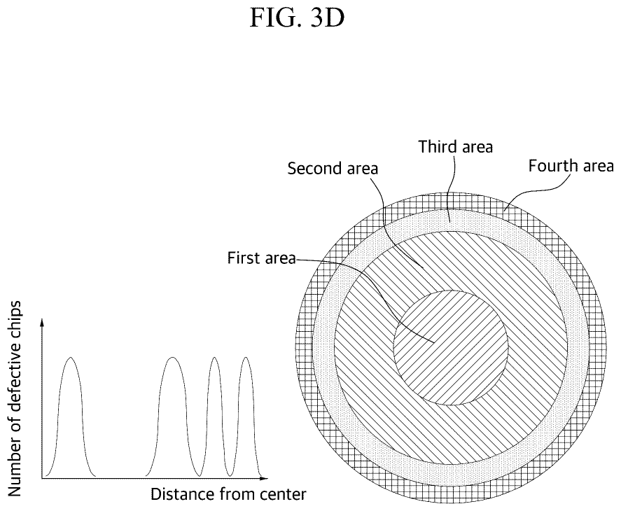

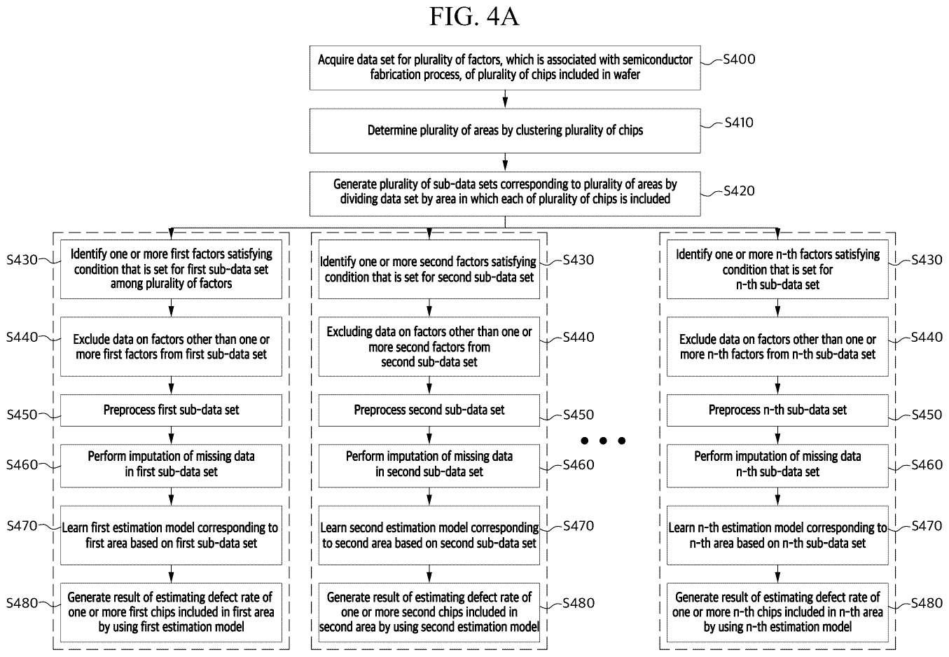

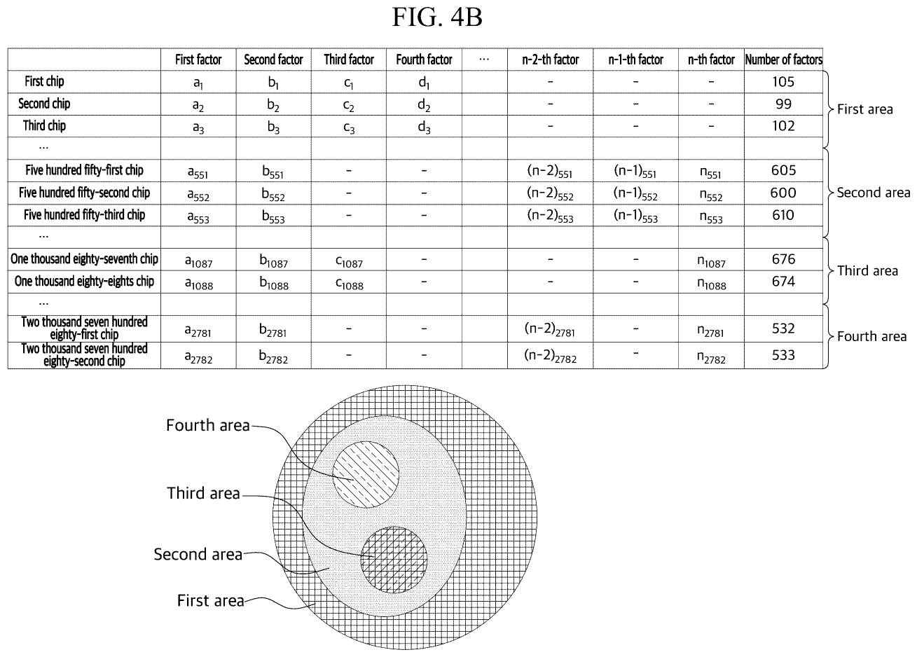

As such, since a factor in which data is acquired may vary by area in which the plurality of chips is included, instead of learning one estimation model based on the entire data set as in a typical electronic device, the electronic device 100 of one or more embodiments may learn different estimation models based on data different for each area. Through this, the electronic device 100 of one or more embodiments may improve performance of an estimation model. For example, the electronic device 100 may divide the data set into a plurality of sub-data sets and then learn estimation models different for each area based on a sub-data set in which a factor not having data are removed. In this regard, examples of a detailed process of operation of the electronic device 100 will be described below with reference to FIGS. 3A through 3D and FIGS. 4A through 4B.

FIG. 3A illustrates a process of the electronic device 100 learning a model for estimating a defect rate of a chip according to one or more embodiments. FIG. 3B illustrates an example of a plurality of areas in a wafer according to one or more embodiments. FIG. 3C illustrates an example of a plurality of areas in the wafer determined based on a measurement point according to one or more embodiments. FIG. 3D illustrates an example of a plurality of areas in the wafer determined based on a distribution of defective chips according to one or more embodiments. Operations S300 to S308 of FIG. 3A may be performed in the sequence and manner as illustrated in FIG. 3A. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation S300, the electronic device 100 may acquire a data set for a plurality of factors, which is associated with a semiconductor fabrication process, of a plurality of chips included in the wafer. For example, the electronic device 100 may acquire the data set which includes category data on an apparatus used in the semiconductor fabrication process for the plurality of chips included in the wafer and measurement data measured for the plurality of chips.

In operation S310, the electronic device 100 may identify chips included in each of the plurality of areas based on location data corresponding to each of the plurality of chips. For example, the electronic apparatus 100 may identify n areas forming the wafer. In response to identifying the n areas, the electronic device 100 may identify, based on the location data corresponding to each of the plurality of chips included in the data set, which area among the identified n areas each of the plurality of chips is included in.

The location data on the plurality of chips may be shown in a form of an (x, y) coordinate value, a form of a distance from a center of the wafer, and/or the like. However, a form of the location data is not limited to the above description.

According to one or more embodiments, the electronic device 100 may divide the wafer into the plurality of areas based on various factors. For example, the electronic device 100 may divide the wafer into the plurality of areas based on the distance from the center of the wafer, a location at which the measurement data is acquired, and the distribution of the defective chips.

As an example, referring to FIG. 3B, the electronic device 100 may divide, according to the distance from the center of the wafer, the wafer into a first area within a range of a diameter of r1 from the center of the wafer, a second area within a range from the diameter of r1 to a diameter of r2 from the center of the wafer, a third area within a range from the diameter of r2 to a diameter of r3 from the center of the wafer, and a fourth area within a range from the diameter of r3 to a diameter of r4 from the center of the wafer. The diameters r1, r2, r3, and r4 may be measured in millimeters (mm), as a non-limiting example.

As another example, referring to FIG. 3C, the electronic device 100 may identify thirteen measurement points at which the measurement data is acquired, and in response to identifying the measurement points, the electronic device 100 may divide the wafer into three areas such that a first area includes a measure point positioned at the center of the wafer, such that a second area includes four measure points positioned at a first distance from the center of the wafer, and such that a third area includes eight measure points positioned at a second distance from the center of the wafer.

As another example, referring to FIG. 3D, the electronic device 100 may identify the distribution of the defective chips with respect to the distance from the center of the wafer, and in response to identifying the distribution, the electronic device 100 may divide the wafer into four areas such that each area includes a location at which defective chips are densely distributed. For example, the electronic device 100 may determine a plurality of ranges of distances from the center that each correspond to a number of defective chips greater than or equal to a predetermined threshold value, and may divide the wafer into areas such that each of the areas corresponds to a respective one of the ranges.

However, the above-mentioned areas, measurement points, and distribution of the defective chips are merely an example. It is apparent to those skilled in the art that the present one or more embodiments may be implemented in a way different from the above description.

In operation S320, the electronic device 100 may divide the data set by area in which each of the plurality of chips is included, such that a plurality of sub-data sets corresponding to the plurality of areas may be generated. For example, the electronic device 100 may identify a chip included in a first area among the plurality of areas and identify one or more rows including data corresponding to the chip included in the first area in the data set which has a tabular structure, and in response to identifying the chip and the one or more rows, the electronic device 100 may generate a first sub-data set including the one or more rows. In this way, the electronic device 100 may generate n sub-data sets individually corresponding to the n areas forming the wafer.

In operation S330, the electronic device 100 may identify one or more first factors satisfying a condition that is set for the first sub-data set among the plurality of factors. For example, the electronic device 100 may identify at least one of a factor of which corresponding data is included in the first sub-data set among the plurality of factors, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of a first estimation model is greater than or equal to a second threshold value, and a factor of which a value showing a contribution to an output of the first estimation model is greater than or equal to a second percentile.

As an example, the electronic device 100 may identify a factor of which corresponding data is included in the first sub-data set among the plurality of factors as the one or more first factors satisfying the condition that is set for the first sub-data set.

As another example, the electronic device 100 may identify a factor, of which a standard deviation or an entropy value of corresponding data is greater than or equal to the first threshold value among the plurality of factors, as the one or more first factors satisfying the condition that is set for the first sub-data set.

As another example, the electronic device 100 may identify a factor, of which a standard deviation or an entropy value of corresponding data is within top 10% among the plurality of factors, as the one or more first factors satisfying the condition that is set for the first sub-data set.

As another example, the electronic device 100 may identify a factor, of which a corresponding SHapley Additive exPlanations (SHAP) value, attention weight, and/or the like is greater than or equal to the second threshold value among the plurality of factors, as the one or more first factors satisfying the condition that is set for the first sub-data set.

As another example, the electronic device 100 may identify a factor, of which an SHAP value, attention weight, and/or the like is within top 5% among the plurality of factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a standard deviation or an entropy value of corresponding data is greater than or equal to the first threshold value among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a standard deviation or an entropy value of corresponding data is within top 10% among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a corresponding SHAP value, attention weight, and/or the like is greater than or equal to the second threshold value among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a corresponding SHAP value, attention weight, and/or the like is within top 5% among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify factors, of which standard deviations or entropy values of corresponding data are greater than or equal to the first threshold value among the identified factors, and identify a factor, of which a corresponding SHAP value, attention weight, and/or the like is within top 5% among the identified factors, as the one or more first factors satisfying the condition that is set for the first sub-data set.

As another example, the electronic device 100 may identify factors of which corresponding data is included in a sub-data set among the plurality of factors, and in response to identifying the factors, the electronic device 100 may identify factors, of which corresponding SHAP values, attention weights, and/or the like are greater than or equal to the second threshold value among the identified factors, and identify a factor, of which a standard deviation or an entropy value is within top 10% among the identified factors, as the one or more first factors satisfying the condition that is set for the first sub-data set.

In this way, the electronic device 100 may perform an operation of identifying one or more second factors satisfying a condition that is set for a second sub-data set and/or an operation of identifying one or more n-th factors satisfying a condition that is set for an n-th sub-data set.

In operation S340, the electronic device 100 may exclude data on factors other than the one or more first factors from the first sub-data set. For example, the electronic device 100 may generate the first sub-data set which includes data on the one or more first factors of the chip included in the first area by excluding factors not satisfying the set condition from the first sub-data set. In this way, the electronic device 100 may perform an operation of excluding data on factors other than the one or more second factors from the second sub-data set or an operation of excluding data on factors other than the one or more n-th factors from the n-th sub-data set.

In operation S350, the electronic device 100 may preprocess the first sub-data set. For example, the electronic device 100 may perform an operation such as detecting an extreme anomaly in data included in the first sub-data set to remove or correct the anomaly, converting category data into numerical data, and/or normalizing or standardizing data. However, a preprocessing process performed by the electronic device 100 is not limited to the above-description. In this way, the electronic device 100 may perform an operation of preprocessing the second sub-data set and/or an operation of preprocessing the n-th sub-data set.

In operation S360, the electronic device 100 may perform imputation of missing data (e.g., replace the missing data with generated data) in the first sub-data set. For example, the electronic device 100 may identify the missing data in the first sub-data set and replace the missing data with an average value, a mode, and/or a median of pieces of data corresponding to an identical factor. However, when data in the first sub-data set is not missing, the electronic device 100 may omit operation S360. In this way, the electronic device 100 may perform an operation of imputation of missing data in the second sub-data set and/or an operation of imputation of missing data in the n-th sub-data set.

In operation S370, the electronic device 100 may learn (e.g., train) the first estimation model which corresponds to the first area based on the first sub-data set. For example, the electronic device 100 may learn a model for estimating defect rates of chips included in the first area with data on the one or more first factors of a first chip included in the first area and data on whether the first chip is defective as input data and answer data, respectively. In this way, the electronic device 100 may perform an operation of learning a second estimation model corresponding to a second area based on second sub-data set and/or an operation of learning an n-th estimation model corresponding to an n-th area based on n-th sub-data set.

According to one or more embodiments, the electronic device 100 may generate one model by integrating a plurality of estimation models corresponding to the plurality of areas in the wafer. For example, the electronic device 100 may generate an integrated model including n estimation models individually corresponding to the n areas in the wafer. As another example, each of the first through n-th estimation models may be a same estimation model, wherein the learning of the estimation model is performed in n iterations based on the respective first through n-th sub-data sets.

In operation S380, the electronic device 100 may generate a result of estimating a defect rate of one or more first chips included in the first area by using the first estimation model. For example, the electronic device 100 may estimate the defect rates of the chips included in the first area by inputting data on chips included a first area of another wafer to the first estimation model in the integrated model. In this way, the electronic device 100 may perform an operation of generating a result of estimating a defect rate of one or more second chips included in the second area by using the second estimation model and/or an operation of generating a result of estimating a defect rate of one or more n-th chips included in the n-th area by using the n-th estimation model.

FIG. 4A illustrates a process of the electronic device 100 learning a model for estimating a defect rate of a chip according to one or more embodiments. FIG. 4B illustrates a process of the electronic device 100 determining a plurality of areas in a wafer based on the number of factors corresponding to chips according to one or more embodiments. The above description with reference to FIG. 3 will be simplified or omitted.

In operation S400, the electronic device 100 may acquire a data set for a plurality of factors, which is associated with a semiconductor fabrication process, of a plurality of chips included in the wafer. For example, the electronic device 100 may acquire the data set which includes category data on an apparatus used in the semiconductor fabrication process for the plurality of chips included in the wafer and measurement data measured for the plurality of chips.

In operation S410, the electronic device 100 may determine the plurality of areas by clustering the plurality of chips. For example, the electronic device 100 may identify, for each of the plurality of chips, the number of factors of which corresponding data is included in the data set and cluster the plurality of chips based on the number of the factors which are included in the data set, which is identified for each of the plurality of chips. Through this, the plurality of areas may be determined.

For example, referring to FIG. 4B, the electronic device 100 may identify, for each of first to two thousand seven hundred eighty-second chips, the number of factors of which corresponding data is included in the data set, and in response to identifying the number of factors, the electronic device 100 may use various clustering techniques such as density-based spatial clustering of applications with noise (DBSCAN) and/or ordering points to identify clustering structure (OPTICS) to determine first to fourth areas in the wafer such that a first area includes first to third chips having similar numbers of factors of which corresponding data is included in the data set, such that a second area includes five hundred fifty-first to five hundred fifty-third chips having similar numbers of factors of which corresponding data is included in the data set, such that a third area includes one thousand eighty-seventh to one thousand eighty-eighth chips having similar numbers of factors of which corresponding data is included in the data set, and such that a fourth area includes two thousand seven hundred eighty-first to two thousand eighty second chips having similar numbers of factors of which corresponding data is included in the data set. Accordingly, the plurality of areas may be determined such that chips having similar numbers of corresponding factors are included in an identical area.

In operation S420, the electronic device 100 may generate a plurality of sub-data sets corresponding to the plurality of areas by dividing the data set by area in which each of the plurality of chips is included. For example, the electronic device 100 may identify a chip included in the first area among the plurality of areas and identify one or more rows including data corresponding to the chip included in the first area in the data set which has a tabular structure, and in response to identifying the chip and the one or more rows, the electronic device 100 may generate a first sub-data set including the one or more rows. In this way, the electronic device 100 may generate n sub-data sets individually corresponding to n areas forming the wafer.

In operation S430, the electronic device 100 may identify one or more first factors satisfying a condition that is set for the first sub-data set among the plurality of factors. For example, the electronic device 100 may identify at least one of a factor of which corresponding data is included in the first sub-data set, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of a first estimation model is greater than or equal to a second threshold value, and a factor of which a value showing a contribution to an output of the first estimation model is greater than or equal to a second percentile.

As an example, the electronic device 100 may identify a factor of which corresponding data is included in the first sub-data set among the plurality of factors as the one or more first factors satisfying the condition that is set for the first sub-data set.

As another example, the electronic device 100 may identify a factor, of which a standard deviation or an entropy value of corresponding data is greater than or equal to the first threshold value among the plurality of factors, as the one or more first factors satisfying the condition that is set for the first sub-data set.

As another example, the electronic device 100 may identify a factor, of which a standard deviation or an entropy value of corresponding data is within top 10% among the plurality of factors, as the one or more first factors satisfying the condition that is set for the first sub-data set.

As another example, the electronic device 100 may identify a factor, of which a corresponding SHAP value, attention weight, and/or the like is greater than or equal to the second threshold value among the plurality of factors, as the one or more first factors satisfying the condition that is set for the first sub-data set.

As another example, the electronic device 100 may identify a factor, of which an SHAP value, attention weight, and/or the like is within top 5% among the plurality of factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a standard deviation or an entropy value of corresponding data is greater than or equal to the first threshold value among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a standard deviation or an entropy value of corresponding data is within top 10% among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a corresponding SHAP value, attention weight, and/or the like is greater than or equal to the second threshold value among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify a factor, of which a corresponding SHAP value, attention weight, and/or the like is within top 5% among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify factors, of which standard deviations or entropy values of corresponding data are greater than or equal to the first threshold value among the identified factors, and identify a factor, of which a corresponding SHAP value, attention weight, and/or the like is within top 10% among the identified factors, as the one or more first factors satisfying the condition that is set for the first sub-data set.

As another example, the electronic device 100 may identify factors of which corresponding data is included in the first sub-data set among the plurality of factors, and in response to identifying the factors, the electronic device 100 may identify factors, of which corresponding SHAP values, attention weights, and/or the like are greater than or equal to the second threshold value among the identified factors, and identify a factor, of which a standard deviation or an entropy value is within top 15% among the identified factors, as the one or more first factors satisfying the condition that is set for the first sub-data set.

In this way, the electronic device 100 may perform an operation of identifying one or more second factors satisfying a condition that is set for a second sub-data set and/or an operation of identifying one or more n-th factors satisfying a condition that is set for an n-th sub-data set.

In operation S440, the electronic device 100 may exclude data on factors other than the one or more first factors from the first sub-data set. For example, the electronic device 100 may generate the first sub-data set which includes data on the one or more first factors of the chip included in the first area by excluding factors not satisfying the set condition from the first sub-data set. In this way, the electronic device 100 may perform an operation of excluding data on factors other than the one or more second factors from the second sub-data set or an operation of excluding data on factors other than the one or more n-th factors from the n-th sub-data set.

In operation S450, the electronic device 100 may preprocess first sub-data set. For example, the electronic device 100 may perform an operation such as detecting an extreme anomaly in data included in the first sub-data set to remove or correct the anomaly, converting category data into numerical data, and/or normalizing or standardizing data. However, a preprocessing process performed by the electronic device 100 is not limited to the above-description. In this way, the electronic device 100 may perform an operation of preprocessing the second sub-data set or an operation of preprocessing the n-th sub-data set.

In operation S460, the electronic device 100 may perform imputation of missing data (e.g., replace the missing data with generated data) in the first sub-data set. For example, the electronic device 100 may identify the missing data in the first sub-data set and replace the missing data with an average value, a mode, and/or a median of pieces of data corresponding to an identical factor. However, when data in the first sub-data set is not missing, the electronic device 100 may omit operation S460. In this way, the electronic device 100 may perform an operation of imputation of missing data in the second sub-data set and/or an operation of imputation of missing data in the n-th sub-data set.

In operation S470, the electronic device 100 may learn (e.g., train) the first estimation model which corresponds to the first area based on the first sub-data set. For example, the electronic device 100 may learn a model for estimating defect rates of chips included in the first area with data on the one or more first factors of a first chip included in the first area and data on whether the first chip is defective as input data and answer data, respectively. In this way, the electronic device 100 may perform an operation of learning a second estimation model corresponding to a second area based on second sub-data set and/or an operation of learning an n-th estimation model corresponding to an n-th area based on n-th sub-data set.

In operation S480, the electronic device 100 may generate a result of estimating a defect rate of one or more first chips included in the first area by using the first estimation model. For example, the electronic device 100 may estimate the defect rates of the chips included in the first area by inputting data on chips included a first area of another wafer to the first estimation model. In this way, the electronic device 100 may perform an operation of generating a result of estimating a defect rate of one or more second chips included in the second area by using the second estimation model and/or an operation of generating a result of estimating a defect rate of one or more n-th chips included in the n-th area by using the n-th estimation model.

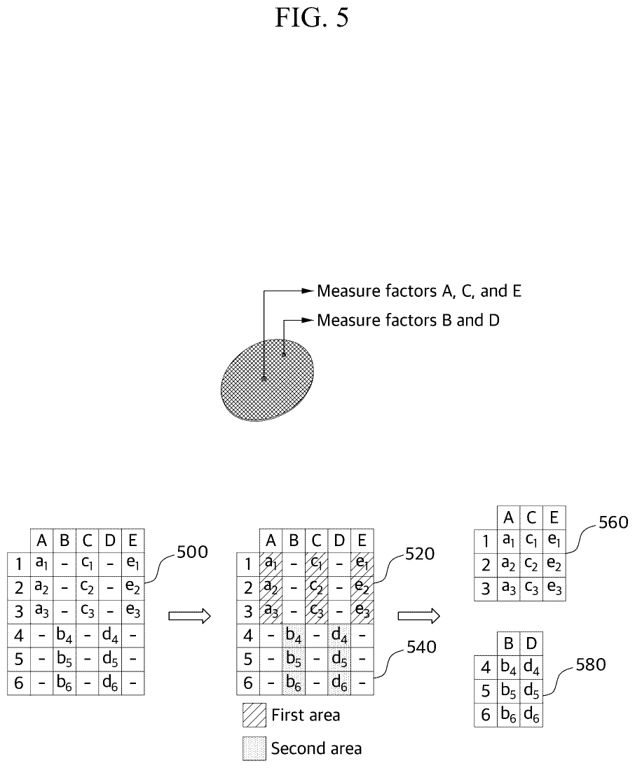

FIG. 5 illustrates a process of the electronic device 100 generating a plurality of sub-data sets by dividing a data set according to one or more embodiments.

According to one or more embodiments, the electronic device 100 may acquire a data set for a plurality of factors, which is associated with a semiconductor fabrication process, of a plurality of chips included in a wafer. For example, referring to FIG. 5, the electronic device 100 may acquire a data set 500 for five factors (e.g., a factor A, a factor B, a factor C, a factor B, and a factor D) of six chips included in the wafer.

The electronic device 100 may identify chips individually included in a plurality of areas based on location data corresponding to each of the plurality of chips. For example, the electronic device 100 may identify that a first chip, a second chip, and a third chip are included in a first area in the wafer and that a fourth chip, a fifth chip, and a sixth chip are included in a second area in the wafer based on location data of each of the first chip, the second chip, the third chip, the fourth chip, the fifth chip, and the sixth chip.

Here, the electronic device 100 may generate a plurality of sub-data sets corresponding to the plurality of areas by dividing the data set by area in which each of the plurality of chips is included. For example, referring to FIG. 5, the electronic device 100 may identify the first chip, the second chip, and the third chip included in the first area among the plurality of areas and generate a first sub-data set 520 including first to third rows respectively corresponding to the first chip, the second chip, and the third chip. Alternatively or additionally, referring to FIG. 5, the electronic device 100 may identify the fourth chip, the fifth chip, and the sixth chip included in the second area among the plurality of areas and generate a first sub-data set 540 including fourth to sixth rows respectively corresponding to the fourth chip, the fifth chip, and the sixth chip.

In response to generating of the plurality of sub-data sets, the electronic device 100 may identify one or more factors satisfying a condition that is set for a sub-data set among the plurality of factors. For example, referring to FIG. 5, in response to identifying that data corresponding to the factor A, the factor C, and the factor E among the five factors are included in the first sub-data set 520, the electronic device 100 may identify that the factor A, the factor C, and the factor E satisfy a condition that is set for the first sub-data set 520. Alternatively or additionally, referring to FIG. 5, in response to identifying that data corresponding to the factor B and the factor D among the five factors are included in the first sub-data set 540, the electronic device 100 may identify that the factor B and the factor D satisfy a condition that is set for the first sub-data set 540.

In addition, the electronic device 100 may generate a sub-data set including data on a factor satisfying the condition that is set for the sub-data set among the plurality of factors. For example, referring to FIG. 5, the electronic device 100 may generate a second sub-data set 560 including data on the factor A, the factor C, and the factor E of the first chip, the second chip, and the third chip by excluding data corresponding to the factor B and the factor D not satisfying the set condition from the first sub-data set 520. Alternatively or additionally, referring to FIG. 5, the electronic device 100 may generate a second sub-data set 580 including data on the factor B and the factor D of the fourth chip, the five chip, and the sixth chip by excluding data corresponding to the factor A, the factor C, and the factor E not satisfying the set condition from the first sub-data set 540.

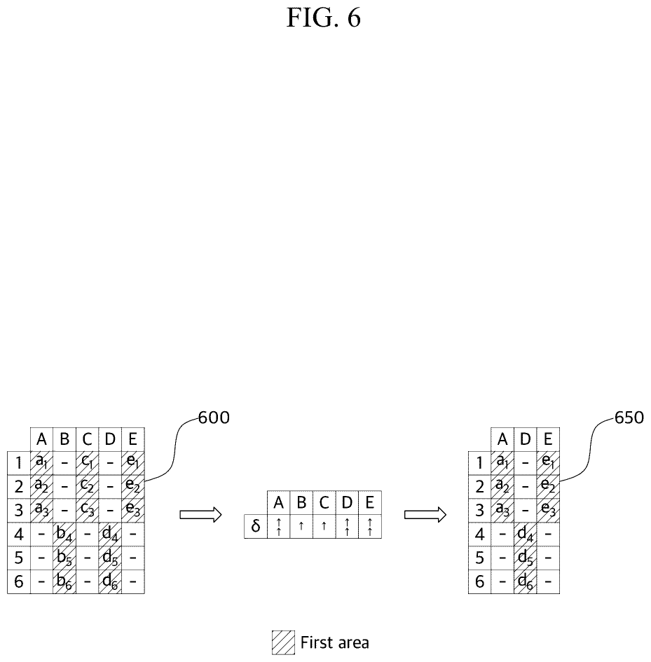

FIG. 6 illustrates a process of the electronic device 100 identifying a factor satisfying a condition that is set for a sub-data set according to one or more embodiments.

According to one or more embodiments, the electronic device 100 may divide a data set by area in which each of a plurality of chips is included, such that a plurality of sub-data sets corresponding to a plurality of areas may be generated. For example, referring to FIG. 6, the electronic device 100 may identify a first chip, a second chip, a third chip, a fourth chip, a fifth chip, and a sixth chip included in a first area among the plurality of areas and generate a first sub-data set 600 including first to sixth rows corresponding to the first chip, the second chip, the third chip, the fourth chip, the fifth chip, and the sixth chip.

In response to generating the plurality of sub-data sets, the electronic device 100 may identify one or more factors satisfying the condition that is set for the sub-data set among a plurality of factors. For example, referring to FIG. 6, the electronic device 100 may identify a standard deviation of data corresponding to a factor A, a factor B, a factor C, a factor D, and a factor E. In response to identifying that a standard deviation of the data corresponding to the factor A, the factor D, and the factor E among the factor A, the factor B, the factor C, the factor D, and the factor E is greater than or equal to a first threshold value, the electronic device 100 may identify that the factor A, the factor D, and the factor E satisfy a condition that is set for the first sub-data set 600.

In this regard, the electronic device 100 may generate a sub-data set including data on a factor satisfying the condition that is set for the sub-data set among the plurality of factors. For example, referring to FIG. 6, the electronic device 100 may generate a second sub-data set 650 including data on the factor A, the factor D, and the factor E of the first chip, the second chip, the third chip, the fourth chip, the fifth chip, and the sixth chip by excluding data corresponding to the factor B and the factor C not satisfying the set condition from the first sub-data set 600.

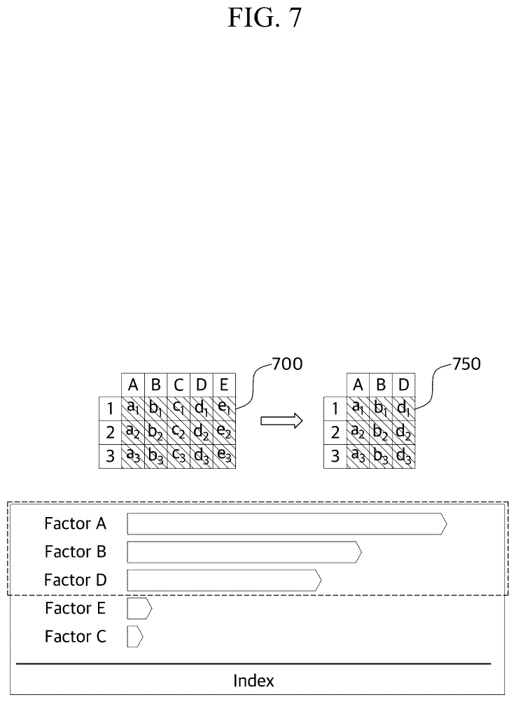

FIG. 7 illustrates a process of the electronic device 100 identifying a factor satisfying a condition that is set for a sub-data set according to one or more embodiments.

According to one or more embodiments, the electronic device 100 may divide a data set by area in which each of a plurality of chips is included, such that a plurality of sub-data sets corresponding to a plurality of areas may be generated. For example, referring to FIG. 7, the electronic device 100 may identify a first chip, a second chip, and a third chip included in a first area among the plurality of areas and generate a first sub-data set 700 including first to third rows corresponding to the first chip, the second chip, and the third chip.

The electronic device 100 may identify one or more factors satisfying the condition that is set for the sub-data set among a plurality of factors. For example, referring to FIG. 7, the electronic device 100 may identify indexes (e.g., SHAP values) corresponding to a factor A, a factor B, a factor C, a factor D, and a factor E. In response to identifying that indexes (e.g., SHAP values) corresponding to the factor A, the factor B, and the factor D among the factor A, the factor B, the factor C, the factor D, and the factor E are greater than or equal to a first threshold value, the electronic device 100 may identify that the factor A, the factor B, and the factor D satisfy a condition that is set for the first sub-data set 700. At this point, a SHAP value is merely one index showing whether the condition is satisfied, and various indexes other than the SHAP value may be applied.

In this regard, the electronic device 100 may generate a sub-data set including data on a factor satisfying the condition that is set for the sub-data set among the plurality of factors. For example, referring to FIG. 7, the electronic device 100 may generate a second sub-data set 750 including data on the factor A, the factor B, and the factor D of the first chip, the second chip, and the third chip by excluding data corresponding to the factor C and the factor E not satisfying the set condition from the first sub-data set 700.

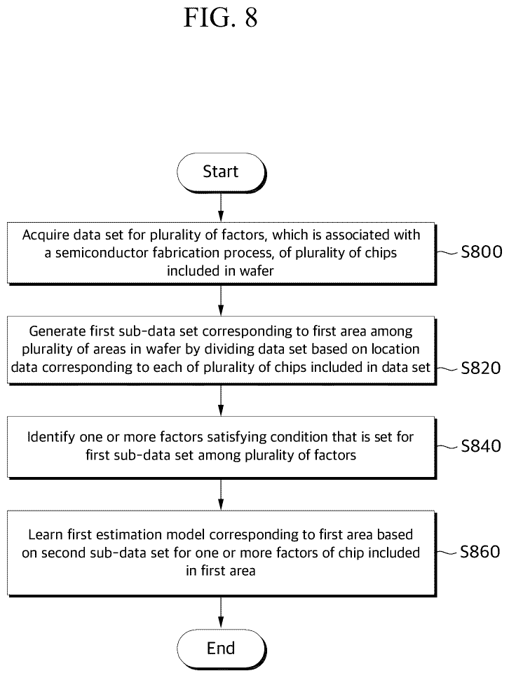

FIG. 8 is a flowchart illustrating an operation method for an electronic device according to one or more embodiments. The above description may be applied to similar descriptions.

In operation S800, the electronic device may acquire a data set for a plurality of factors, which is associated with a semiconductor fabrication process, of a plurality of chips included in a wafer.

The plurality of factors may include a factor for a plurality of apparatuses used in the semiconductor fabrication process and a factor for a plurality of measurement items measured in the semiconductor fabrication process.

In operation S820, the electronic device may generate a first sub-data set corresponding to a first area among a plurality of areas in the wafer by dividing the data set based on location data corresponding to each of the plurality of chips included in the data set.

Here, when generating the first sub-data set, the electronic device may identify chips included in each of the plurality of areas in the wafer based on the location data corresponding to each of the plurality of chips and generate a plurality of sub-data sets corresponding to the plurality of areas by dividing the data set by each area in which the plurality of chips is included.

At this point, the plurality of areas may be determined based on a distance from a center of the wafer. Alternatively or additionally, the plurality of areas may be determined based on the number of measurement points with respect to the distance from the center of the wafer. Alternatively or additionally, the plurality of areas may be determined based on a distribution of defective chips with respect to the distance from the center of the wafer.

In operation S840, the electronic device may identify one or more factors satisfying a condition that is set for the first sub-data set among the plurality of factors.

At this point, the one or more factors satisfying the condition that is set for the first sub-data set may include at least one of a factor of which corresponding data is included in the first sub-data set, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of a first estimation model is greater than or equal to a second threshold value, and a factor of which a value showing a contribution to an output of the first estimation model is greater than or equal to a second percentile.

In operation S860, the electronic device may learn (e.g., train) the first estimation model corresponding to the first area based on a second sub-data set for the one or more factors of a chip included in the first area.

At this point, when learning the first estimation model, the electronic device may preprocess the second-sub data set and perform an operation of imputation of missing data in the second sub-data set.

Meanwhile, the electronic device may estimate a defect rate of the chip included in the first area by using the first estimation model. In addition, the electronic device may learn a second estimation model corresponding to a second area different from the first area among the plurality of areas and generate an integrated model into which the first estimation model and the second estimation model are integrated.

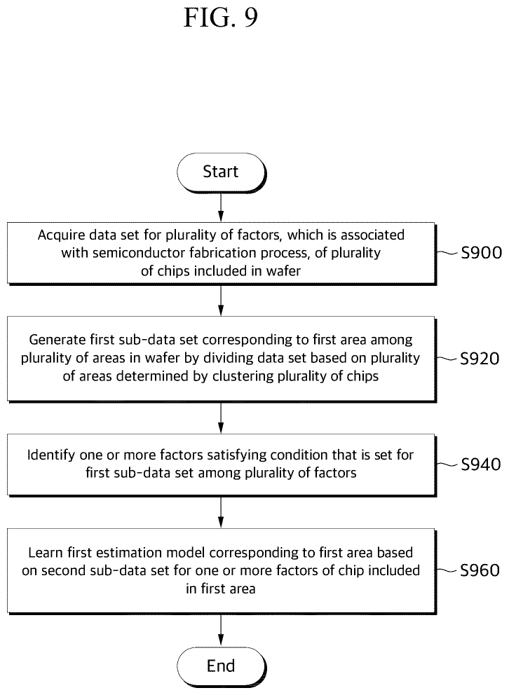

FIG. 9 is a flowchart illustrating an operation method for an electronic device according to one or more embodiments. The above description may be applied to similar descriptions.

In operation S900, the electronic device may acquire a data set for a plurality of factors, which is associated with a semiconductor fabrication process, of a plurality of chips included in a wafer.

At this point, the plurality of factors may include a factor for a plurality of apparatuses used in the semiconductor fabrication process and a factor for a plurality of measurement items measured in the semiconductor fabrication process.

In operation S920, the electronic device may generate a first sub-data set corresponding to a first area among a plurality of areas in the wafer by dividing the data set based on a plurality of areas determined by clustering the plurality of chips.

Here, the electronic device may identify, for each of the plurality of chips, the number of factors of which corresponding data is included in the data set and determine the plurality of areas by clustering the plurality of chips based on the number of the factors which are included in the data set, which is identified for each of the plurality of chips.

In operation S940, the electronic device may identify one or more factors satisfying a condition that is set for the first sub-data set among the plurality of factors.

At this point, the one or more factors satisfying the condition that is set for the first sub-data set may include at least one of a factor of which corresponding data is included in the first sub-data set, a factor of which a value showing an amount of information of corresponding data is greater than or equal to a first threshold value, a factor of which a value showing an amount of information of corresponding data is greater than or equal to a first percentile among the plurality of factors, a factor of which a value showing a contribution to an output of a first estimation model is greater than or equal to a second threshold value, and a factor of which a value showing a contribution to an output of the first estimation model is greater than or equal to a second percentile.

In operation S960, the electronic device may learn (e.g., train) the first estimation model corresponding to the first area based on a second sub-data set for the one or more factors of a chip included in the first area.

At this point, when learning the first estimation model, the electronic device may preprocess the second-sub data set and perform an operation of imputation of missing data in the second sub-data set.

Meanwhile, the electronic device may estimate a defect rate of the chip included in the first area by using the first estimation model. In addition, the electronic device may learn a second estimation model corresponding to a second area different from the first area among the plurality of areas and generate an integrated model into which the first estimation model and the second estimation model are integrated.

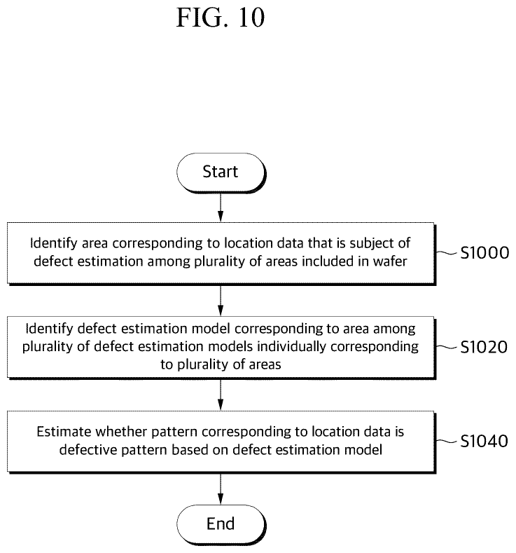

FIG. 10 is a flowchart illustrating an operation method for an electronic device according to one or more embodiments. The above description may be applied to similar descriptions.

In operation S1000, the electronic device may identify an area corresponding to location data that is a subject of defect estimation among a plurality of areas included in a wafer.

At this point, the electronic device may identify the area corresponding to the location data that is the subject of the defect estimation, based on at least one of defect history data, measurement data measure for a plurality of chips, and process history data on the plurality of chips.

As an example, the electronic device may identify positions of chips that have been defective in a wafer processed earlier and determine an area corresponding to the positions to be a defect estimation subject area.

As another example, the electronic device may identify positions of chips that have a high possibility of being defective based on a pattern formed in a photolithography process, etching depth, deposition thickness, doping concentration, and/or the like and may determine an area corresponding to the positions to be a defect estimation subject area.

In operation S1020, the electronic device may identify a defect estimation model corresponding to the area among a plurality of defect estimation models individually corresponding to the plurality of areas.

At this point, the plurality of defect estimation models individually corresponding to the plurality of areas may be models that have learned a defect pattern corresponding to each of the plurality of areas based on data sets individually corresponding to the plurality of areas.

In operation S1040, the electronic device may estimate whether a pattern corresponding to the location data is a defective pattern based on the defect estimation model.

At this point, the electronic device may identify whether the pattern corresponding to the location data is the defective pattern by inputting a data set of one or more chips included in the area to the defect estimation model.

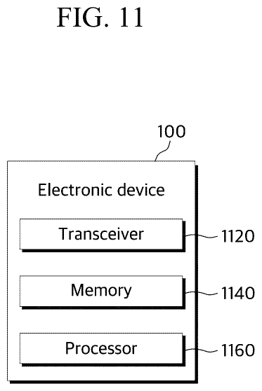

FIG. 11 is a block diagram illustrating the electronic device 100 according to one or more embodiments.

According to one or more embodiments, the electronic device 100 may include a transceiver 1120 (e.g., one or more transceivers), a memory 1140 (e.g., one or more memories), and a processor 1160 (e.g., one or more processors). Particular elements, which are associated with the present one or more embodiments, are illustrated with respect to the electronic device 100 which is illustrated in FIG. 11. Thus, those skilled in the art associated with the present one or more embodiments may understand that other elements in general use in addition to the elements illustrated in FIG. 11 may be further included. In one or more embodiments, the transceiver 1120 may be included in a communication device.

The transceiver 1120 may be device for performing wired/wireless communication and communicate with an external electronic device. The external electronic device may be a terminal or a server. Also, a communication technology used by the transceiver 1120 may include Global System for Mobile communication (GSM), Code Division Multi Access (CDMA), Long Term Evolution (LTE), 5th Generation, (5G), a wireless local area network (WLAN), Wireless-Fidelity (Wi-Fi), Bluetooth, radio frequency identification (RFID), infrared data association (IrDA), ZigBee, near field communication (NFC), and/or the like.

The processor 1160 may control overall operations of the electronic device 100 and process data and a signal. The processor 1160 may be formed of at least one hardware unit. In addition, the processor 1160 may be operated by one or more software modules generated by executing program code stored in the memory 1140. For example, the memory 1140 may be or include a non-transitory computer-readable storage medium storing instructions that, when executed by the processor 1160, configure the processor 1160 to perform any one, any combination, or all of the operations and/or method described herein with reference to FIGS. 1-11. Since the processor 1160 may include a memory, the processor 1160 may control the overall operations of the electronic device 100 and process the data and the signal by executing program code stored in the memory.

The processor 1160 may acquire a data set for a plurality of factors, which is associated with a semiconductor fabrication process, of a plurality of chips included in a wafer, generate a first sub-data set corresponding to a first area among a plurality of areas in the wafer by dividing the data set based on location data corresponding to each of the plurality of chips included in the data set, identify one or more factors satisfying a condition that is set for the first sub-data set among the plurality of factors, and learn a first estimation model corresponding the first area based on a second sub-data set for the one or more factors of a chip included in the first area.

The processor 1160 may acquire a data set for a plurality of factors, which is associated with a semiconductor fabrication process, of a plurality of chips included in a wafer, generate, by dividing the data set based on a plurality of areas determined by clustering the plurality of chips, a first sub-data set corresponding to a first area among the plurality of areas in a first wafer, identify one or more factors satisfying a condition that is set for the first sub-data set among the plurality of factors, and learn a first estimation model corresponding the first area based on a second sub-data set for the one or more factors of a chip included in the first area.

The processor 1160 may identify an area corresponding to location data that is a subject of defect estimation among a plurality of areas included in a wafer, identify an estimation model corresponding to the area among a plurality of estimation models individually corresponding to the plurality of areas, and estimate whether a pattern corresponding to the location data is a defective pattern based on the estimation model.

The electronic devices, transceivers, memories, processors, electronic device 100, transceiver 1120, memory 1140, and processor 1160 described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-11 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
acquiring a data set for a plurality of factors, which is associated with a semiconductor fabrication process, of a plurality of chips included in a wafer;
generating a first sub-data set corresponding to a first area among a plurality of areas in the wafer by dividing the data set based on location data corresponding to each of the plurality of chips, the location data included in the data set;
identifying, from among the plurality of factors, one or more factors satisfying a condition that is set for the first sub-data set; and
learning a first estimation model corresponding the first area based on a second sub-data set for the one or more factors of a chip included in the first area.

2. The method of claim 1, wherein the generating of the first sub-data set comprises:
identifying chips included in each of the plurality of areas based on the location data corresponding to each of the plurality of chips; and
generating a plurality of sub-data sets corresponding to the plurality of areas by dividing the data set by area in which each of the plurality of chips is included.

3. The method of claim 2, wherein the plurality of areas are determined based on a distance from a center of the wafer.

4. The method of claim 2, wherein the plurality of areas are determined based on a measurement point with respect to a distance from a center of the wafer.

5. The method of claim 2, wherein the plurality of areas are determined based on a distribution of defective chips with respect to a distance from a center of the wafer.

6. The method of claim 1, wherein the one or more factors satisfying the condition that is set for the first sub-data set includes any one or any combination of any two or more of:
a factor of which corresponding data is included in the first sub-data set;
a factor of which a value showing an amount of information of corresponding data is greater than or equal to a first threshold value;
a factor of which a value showing an amount of information of corresponding data is greater than or equal to a first percentile among the plurality of factors;
a factor of which a value showing a contribution to an output of the first estimation model is greater than or equal to a second threshold value; and
a factor of which a value showing a contribution to an output of the first estimation model is greater than or equal to a second percentile among the plurality of factors.

7. The method of claim 1, wherein the learning of the first estimation model comprises:
preprocessing the second sub-data set; and
performing an operation of imputation of missing data in the second sub-data set.

8. The method of claim 1, further comprising estimating a defect rate of the chip included in the first area by using a first estimation model.

9. The method of claim 1, wherein the plurality of factors includes:
a factor for a plurality of apparatuses used in the semiconductor fabrication process; and
a factor for a plurality of measurement items measured in the semiconductor fabrication process.

10. The method of claim 1, further comprising:
learning a second estimation model corresponding to a second area different from the first area among the plurality of areas; and
generating an integrated model including the first estimation model and the second estimation model.

11. The method of claim 1,
wherein the generating of the first sub-data set comprises generating the first sub-data set by dividing the data set based on a plurality of areas determined by clustering the plurality of chips, and
further comprising:
identifying an area corresponding to location data that is a subject of defect estimation among the plurality of areas;
identifying, from among a plurality of estimation models individually corresponding to the plurality of areas, the learned first estimation model as an estimation model corresponding to the area; and
estimating whether a pattern corresponding to the location data that is the subject of defect estimation is a defective pattern based on the estimation model corresponding to the area.

12. A non-transitory computer-readable storage medium storing instructions that, when executed by one or more processors, configure the one or more processors to perform the method of claim 1.

13. A processor-implemented method comprising:
acquiring a data set for a plurality of factors, which is associated with a semiconductor fabrication process, of a plurality of chips included in a wafer;
generating a first sub-data set corresponding to a first area among a plurality of areas in the wafer by dividing the data set based on a plurality of areas determined by clustering the plurality of chips;
identifying, from among the plurality of factors, one or more factors satisfying a condition that is set for the first sub-data set; and
learning a first estimation model corresponding the first area based on a second sub-data set for the one or more factors of a chip included in the first area.

14. The method of claim 13, wherein the generating of the first sub-data set comprises:
identifying, for each of the plurality of chips, a number of factors of which corresponding data is included in the data set; and
determining the plurality of areas by clustering the plurality of chips based on the number of the factors which are included in the data set, which is identified for each of the plurality of chips.

15. The method of claim 13, wherein the one or more factors satisfying the condition that is set for the first sub-data set includes any one or any combination of any two or more of:
a factor of which corresponding data is included in the first sub-data set;
a factor of which a value showing an amount of information of corresponding data is greater than or equal to a first threshold value;
a factor of which a value showing an amount of information of corresponding data is greater than or equal to a first percentile among the plurality of factors;
a factor of which a value showing a contribution to an output of the first estimation model is greater than or equal to a second threshold value; and
a factor of which a value showing a contribution to an output of the first estimation model is greater than or equal to a second percentile among the plurality of factors.

16. The method of claim 13, wherein the learning of the first estimation model comprises:
preprocessing the second sub-data set; and
performing an operation of imputation of missing data in the second sub-data set.

17. The method of claim 13, further comprising estimating a defect rate of the chip included in the first area by using a first estimation model.

18. The method of claim 13, wherein the plurality of factors includes:
a factor for a plurality of apparatuses used in the semiconductor fabrication process; and
a factor for a plurality of measurement items measured in the semiconductor fabrication process.

19. A processor-implemented method comprising:
identifying an area corresponding to location data that is a subject of defect estimation among a plurality of areas included in a wafer;
identifying an estimation model corresponding to the area among a plurality of estimation models individually corresponding to the plurality of areas; and
estimating whether a pattern corresponding to the location data is a defective pattern based on the estimation model.

20. The method of claim 19, wherein the plurality of estimation models individually corresponding to the plurality of areas are models that have learned a defect pattern corresponding to each of the plurality of areas based on a sub-data set corresponding to each of the plurality of areas.
